(19) United States
(12) Patent Application Publication
(10) Pub. No.: US 2007/0132797 A1
(43) Pub. Date: Jun. 14, 2007

(54) Power control apparatus and method in an image forming apparatus

(75) Inventor: Seong-nam Jeon, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/528,389

(22) Filed: Sep. 28, 2006

(30) Foreign Application Priority Data
Dec. 13, 2005 (KR) 2005-122430

(51) Int. Cl. B41J 29/38

(52) U.S. Cl. 347/14

(57) ABSTRACT

A power control apparatus and method includes a power detector to detect a power supplied to an image forming apparatus, an information storing unit to store information on a printhead, and an auxiliary power supply unit to supply an auxiliary power to the information storing unit in response to a detection result detected by the power detector.

### CROSS-REFERENCE TO RELATED APPLICATIONS

This application claims priority under 35 U.S.C. §119(a) from Korean Patent Application No. 10-2005-0122430, filed on Dec. 13, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus having a printhead, and more particularly, to a power control apparatus and method of storing use information on a printhead, using a power charged in a capacitor provided to stabilize and supply the power to the printhead, when the power supply necessary to drive a system of an image forming apparatus is interrupted.

2. Description of the Related Art

Information on a printhead is stored in a recording medium, such as a customer replacement memory unit (CRUM) or a flash memory, in order to more accurately and safely control the printhead. The information includes general information such as a producer ID, a model name, manufacturing date, a management number, replacement time, etc., and use information such as the number of discharged ink dots, residual quantity of ink, etc. The use information, such as the number of printed paper, the number of discharged ink dots, and residual quantity of ink, is changed while the printhead performs printing. Therefore, it is required to update and store the information on the printhead stored in the recording medium.

However, the use information on the printhead cannot be stored simultaneously with a discharge operation of ink droplets in a unit of nozzle, because access is done in a unit of sector so as to store the use information on the printhead in real time while printing. Additionally, it is difficult to store the use information simultaneously with the discharge operation of ink droplets in an NV-RAM (EEPROM) due to a limitation of an access rate.

Therefore, the use information on the printhead changed by a current printing operation is temporarily stored in a volatile memory such as a DRAM, and is then updated and stored in a non-volatile memory in a unit or job or page.

Accordingly, if a power supply is suddenly interrupted during the print operation in an image forming apparatus, the use information on the printhead stored temporarily in the volatile memory will be lost before it is stored in the non-volatile memory.

In addition, in storing data, the flash memory performs a write operation after finishing an erase operation. Therefore, when a power supply is suddenly interrupted during the erase operation, codes stored in the flash memory may be broken, which is a serious problem.

A difference between the use information on the printhead stored in the recording medium and actual use information arises from the foregoing problems. Consequently, there is a risk of an accident due to component damage or a fire upon use of the image forming apparatus.

### SUMMARY OF THE INVENTION

The present general inventive concept provides a power control apparatus and method of storing use information on a printhead, using a power charged in a capacitor provided to stabilize and supply a power to the printhead, when a power supply necessary to drive a system of an image forming apparatus is interrupted.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a power control apparatus including a power detector to detect a power supplied to the image forming apparatus, an information storing unit to store information on the printhead, and an auxiliary power supply unit to supply a power to the information storing unit in response to the detection result.

The auxiliary power supply unit may be a capacitor to stabilize and supply the power supplied to the printhead.

The auxiliary power supply unit may supply the power charged in the capacitor to the information storing unit to supply the power to the printhead.

The auxiliary power supply unit may supply the power to the information storing unit when the power detector detects that the power necessary to drive the image forming apparatus is not supplied.

The information storing unit may store the information on the printhead by the power supplied from the auxiliary power supply unit.

The auxiliary power supply unit may further include a discharge unit to discharge the power charged in the capacitor.

The foregoing and/or other aspects of the present general inventive concept may also be achieved by providing a power control method including detecting a power supplied to the image forming apparatus, supplying an auxiliary power in response the detection result, and storing information on the printhead using the supplied auxiliary power.

The supplying of the auxiliary power may include supplying the auxiliary power using the power charged in the capacitor.

The supplying of the auxiliary power may include supplying the auxiliary power when the power necessary to drive the image forming apparatus is not supplied.

The supplying of the auxiliary power may further include discharging the power charged in the capacitor after storing information on the printhead.

The foregoing and/or other aspects of the present general inventive concept may also be achieved by providing a computer-readable record medium in which a program to execute the above method on a computer is recorded.

The foregoing and/or other aspects of the present general inventive concept may also be achieved by providing an image forming apparatus including a printing unit to form an image; an information storing unit to store information on the printing unit, a power supply to supply a power to the printing unit, and a power control unit having a power detector to detect the power supplied to at least one of the printing unit and the information storing unit, and an auxiliary power supply unit to supply an auxiliary power to the information storing unit according to the detected power of the power detector.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1A is a block diagram illustrating a power control apparatus according to an embodiment of the present general inventive concept;

FIG. 1B is a circuit diagram illustrating a power control apparatus according to an embodiment of the present general inventive concept;

FIG. 1C is a circuit diagram illustrating a discharge unit of the power control apparatus of FIG. 1A; and

FIG. 2 is a flowchart illustrating a power control method according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

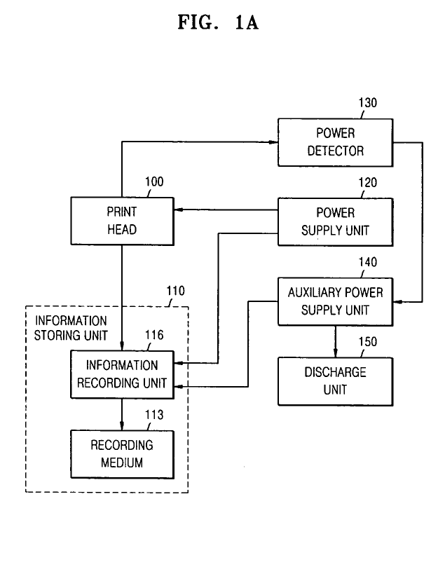

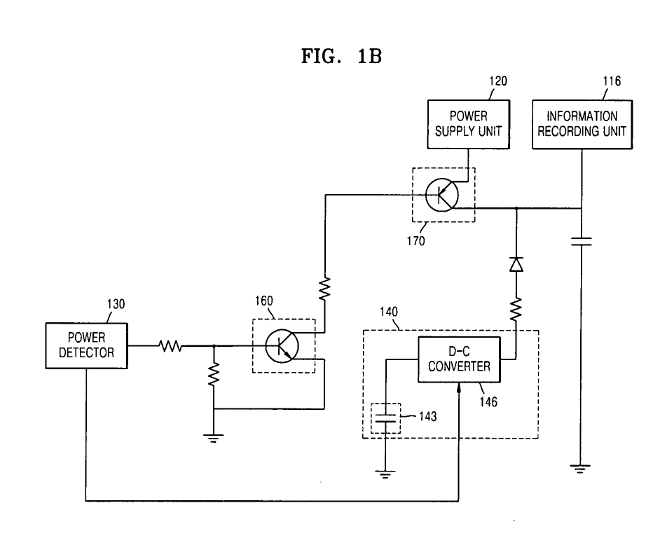

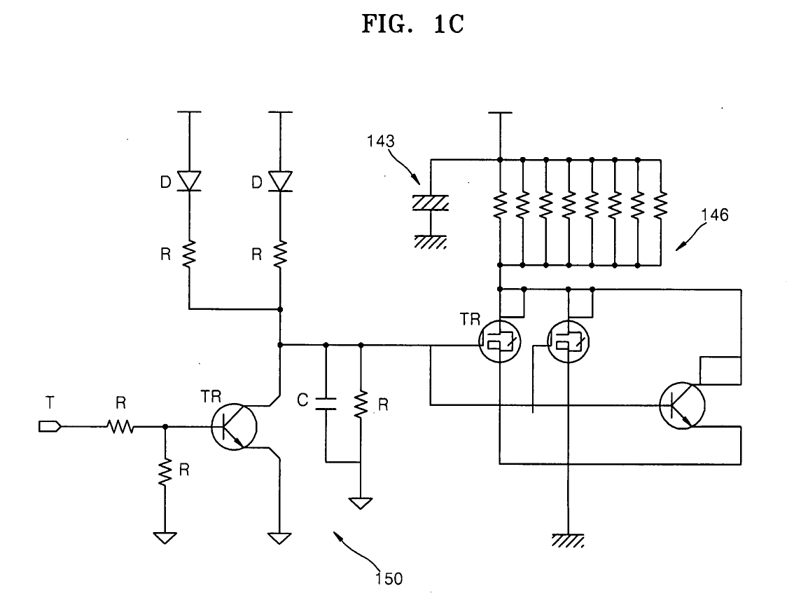

FIG. 1A is a block diagram illustrating a power control apparatus according to an embodiment of the present general inventive concept. Referring to FIG. 1A, the power control apparatus includes a printhead 100, an information storing unit 110, a power supply unit 120, a power detector 130, an auxiliary power supply unit 140, and a discharge unit 150.

The printhead 100 discharges ink droplets by heating ink using a power supplied from the power supply unit 120.

The information storing unit 110 stores information on the printhead. The information includes general information such as a producer ID, a model name, manufacturing date, a product serial number, a production and management number, ink storage capacity, operation environment, replacing time, etc., and use information such as a printed paper number, the number of discharged ink dots, residual quantity of ink, etc. The information storing unit 110 includes a recording medium 113 and an information recording unit 116.

The information on the printhead is stored in the recording medium 113, for example, a customer replacement memory unit (CRUM) or a flash memory.

The information recording unit 116 stores the information on the printhead in the recording medium 113 when the information is updated or changed.

The power supplying unit 120, for example, a switching mode power supply (SMPS), supplies a power necessary to drive a system (or a print unit including the print head 100 and/or the information storing unit 110) of the image forming apparatus.

The power detector 130 detects the power supplied to the system of the image forming apparatus, such as the printhead 100 and/or the information storing unit 110, by the power supply unit 120. The power detector 130 detects the power on the basis of whether the power supplied from the power supply unit 120 is below a predetermined critical value necessary for driving.

The power detector 130 outputs a signal when the power necessary to drive the system of the image forming apparatus is insufficient. Then, the auxiliary power supply unit 140 supplies an auxiliary power to the information recording unit 116 in response to the output signal of the power detector 130.

The auxiliary power supply unit 140 may be a capacitor 143 (FIG. 1B). Since the capacitor 143 is required with an accuracy of approximately 2% with respect to a voltage supplied to the printhead 100 and a change thereof, the capacitor 143 stabilizes and supplies the power supplied to the printhead 100 in order to compensate an instantaneous voltage drop. Thus, the capacitor 143 is used to supply the power to the printhead and 110 and to supply the auxiliary power to the information storing unit 110 according to the output signal of the power detector 130.

Information changed during a print operation is temporarily stored in a volatile memory such as DRAM. The information recording unit 116 stores the temporarily stored information in the recording medium 113 using the auxiliary power supplied from the capacitor 143.

The discharge unit 150 discharges an electric charge charged in the capacitor 143 after recording the information on the printhead 100 in the information recording unit 116.

FIG. 1B is a circuit diagram illustrating a power control apparatus according to an embodiment of the present general inventive concept.

Referring to FIGS. 1A and 1B, the information recording unit 116, the power supply unit 120, the power detector 130, and the auxiliary power supply unit 140 of FIG. 1A are operated in the same manner as FIG. 1B.

The auxiliary power supply unit 140 includes a DC-converter 146 and a capacitor 143. The capacitor 143 may be used in the power supply unit 120 to stabilize the power to be supplied to the information storing unit and/or the system of the image forming apparatus.

The DC-converter 146 supplies the auxiliary power charged in the capacitor 143 to the information recording unit 116 in response to the output signal from the power detector 130.

The capacitor 143 requires the accuracy of 2% about a voltage supplied to the printhead 100 and the change thereof, the capacitor 143 stabilizes and supplies the power supplied to the printhead 100 in order to compensate for instantaneous voltage drop.

The power detector 130 outputs a high level signal when it detects that the power necessary to drive the system of the image forming apparatus is supplied, and outputs a low level signal when it detects that the power to drive the system of the image forming apparatus is insufficient.

If the power detector 130 outputs the high level signal, a transistor (Q1) 160 and a transistor (Q2) 170 are turned-on and the DC-converter 146 becomes disable, so that the power is supplied from the power supply unit 120 to the system of the image forming apparatus.

If the power detector 130 outputs the low level signal, the transistor (Q1) 160 and the transistor (Q2) 170 are turned-off and the DC-converter 146 becomes enable, so that the auxiliary power charged in the capacitor 143 is supplied to the information recording unit 116 to discharge ink from a nozzle of the printhead 110.

Information on the printhead 100 changed during a print operation is temporarily stored in a volatile memory such as DRAM. The information recording unit 116 stores the temporarily stored information in the recording medium 113 using the auxiliary power supplied from the capacitor 143.

FIG. 1C is a circuit diagram illustrating an example of the discharge unit 150 to discharge an electric charge charged in the capacitor 143 after recording information on the printhead 100 in the information recording unit 116. The discharge unit 150 may be connected to the capacitor 143 through a point of the DC-Dc converter 146 to discharge the electric charge of the capacitor 143 according to a signal of a terminal T representing that the information is stored in the information storing unit or that the power supply unit 120 supplies the power necessary to drive the system using diodes D, a capacitor C, resistors R, and transistors TR.

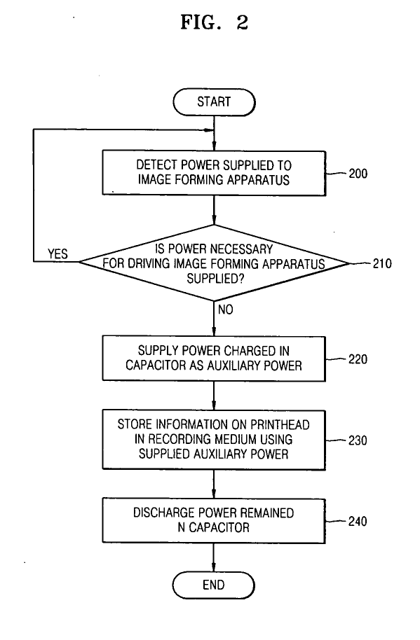

FIG. 2 is a flowchart illustrating the power control method according to an embodiment of the present general inventive concept.

Referring to FIGS. 1A through 2, in operation 200, a power supplied to the system of the image forming apparatus is detected.

In operation 210, it is determined whether a power necessary for driving the system of the image forming apparatus is supplied in response to the result detected in operation 200. In operation 210, it is determined on the basis of whether the power detected in operation 200 is below a predetermined critical power value necessary for driving the system of the image forming apparatus.

In operation 220, a power charged in the capacitor is supplied as the auxiliary power to discharge ink from a nozzle of a printhead when it is determined that the power necessary for driving the image forming apparatus is not supplied in operation 210.

In operation 230, information on the printhead changed during a printing operation, which is temporarily stored in the volatile memory such as DRAM, is stored in the recording medium using the auxiliary power supplied in operation 220. The recording medium, which is the non-volatile memory such as a CRUM or a flash memory, stores information on the printhead including general information and use information.

In operation 240, the power remained in the capacitor is discharged by the circuit shown FIG. 1C.

The general inventive concept can also be embodied as computer-readable codes on a computer-readable recording medium to perform the above-described method. The computer-readable recording medium includes all kinds of data storage devices that can store data which can be thereafter read by a computer system. Examples of the computer-readable recording medium include read-only memory (ROM), random-access memory (RAM), CD-ROMs, magnetic tapes, floppy disks, optical data storage devices, etc.

According to the power control apparatus and method of the present general inventive concept, the use information on the printhead is stored using a power charged in the capacitor, which is provided to stabilize and supply a power to the printhead, if a power supply necessary for driving the system of the image forming apparatus is interrupted.

Therefore, even though a power supply for driving a system is suddenly interrupted during a printing operation in the image forming apparatus, the use information on the printhead can be accurately stored without being lost, and the code stored in the flash memory can be accurately stored without being broken. Additionally, since a power charged in the capacitor during a printing operation is used without an additional power supply unit for the case that a power supply is suddenly interrupted, an additional cost is not generated. Therefore, damage of components of the image forming apparatus is prevented, and users can safely use the apparatus.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A power control apparatus to control a power supplied to an image forming apparatus having a printhead, the power control apparatus comprising:
a power detector to detect the power supplied to the image forming apparatus;
an information storing unit to store information on the printhead; and
an auxiliary power supply unit to supply an auxiliary power to the information storing unit in response to a result detected by the power detector.

2. The power control apparatus of claim 1, wherein the auxiliary power supply unit comprises a capacitor to stabilize and supply the power supplied to the printhead.

3. The power control apparatus of claim 2, wherein the auxiliary power supply unit supplies the auxiliary power charged in the capacitor to the information storing unit to supply the power to the printhead.

4. The power control apparatus of claim 1, wherein the auxiliary power supply unit supplies the auxiliary power to the information storing unit when the power detector detects that the power necessary to drive the image forming apparatus is not supplied.

5. The power control apparatus of claim 1, wherein the information storing unit stores information on the printhead by the power supplied from the auxiliary power supply unit.

6. The power control apparatus of claim 2, further comprising:
a discharge unit to discharge the auxiliary power charged in the capacitor.

7. A power control method of controlling a power supplied to an image forming apparatus having a capacitor to stabilize and supply the power supplied to a printhead, the power control method comprising:
detecting the power supplied to the image forming apparatus;
supplying an auxiliary power in response to the detection result; and
storing information on the printhead using the supplied auxiliary power.

8. The power control method of claim 7, wherein the supplying of the auxiliary power comprises supplying the auxiliary power using a power charged in the capacitor.

9. The power control method of claim 7, wherein the supplying of the auxiliary power comprises supplying the auxiliary power when the power necessary for driving the image forming apparatus is not supplied.

10. The power control method of claim 8, further comprising:
discharging the auxiliary power charged in the capacitor after storing information on the printhead.

11. A computer-readable recording medium in which a program to execute the method of controlling a power to be supplied to an image forming apparatus, the method comprising:
detecting the power supplied to the image forming apparatus;
supplying an auxiliary power in response to the detection result; and
storing information on the printhead using the supplied auxiliary power.

12. An image forming apparatus comprising:
a printing unit to form an image;
an information storing unit to store information on the printing unit;
a power supply to supply a power to the printing unit; and
a power control unit having a power detector to detect the power supplied to at least one of the printing unit and the information storing unit, and an auxiliary power supply unit to supply an auxiliary power to the information storing unit according to the detected power of the power detector.

13. The image forming apparatus of claim 12, wherein the auxiliary power supply comprises a capacitor to stabilize the power of the power supply unit, and to generate a discharge voltage as the auxiliary power when the power is not sufficient.

14. The image forming apparatus of claim 12, wherein the auxiliary power supply comprises a capacitor to stabilize the power of the power supply unit, to have a charged voltage charged during the stabilizing of the power of the power supply unit, and to generate a discharge voltage of the charged voltage as the auxiliary power according to the detected power of the power detector.

15. The image forming apparatus of claim 12, wherein the detector generate a detected signal when the power supplied to the printing unit is changed by 2% of a required voltage, and the controller controls the auxiliary power supply to supply the auxiliary power to the information storing unit according to the detected signal.

16. The image forming apparatus of claim 12, further comprising:
a discharging unit to prevent the supply of the auxiliary power from the auxiliary power supply unit according to a determination of whether the information storing unit stores the information on the printing unit according to the auxiliary power.

17. The image forming apparatus of claim 12, wherein the auxiliary power supply unit terminates the supply of the auxiliary power from the auxiliary power supply unit according to a determination of whether the information storing unit stores the information on the printing unit according to the auxiliary power.

18. The image forming apparatus of claim 12, wherein the auxiliary power supply unit comprises a capacitor and a converter to convert a voltage of the capacitor into another voltage to be used as the auxiliary power.

19. The image forming apparatus of claim 12, further comprising:
a transistor connected between the power supply unit and the information recording unit and controlled by the power detector; and
a diode connected between the auxiliary power supply unit and a junction between the transistor and the information recording unit.

20. The image forming apparatus of claim 19, wherein:
the transistor is active, and the diode is in active; and
the transistor is inactive, and the diode is active to supply the auxiliary power to the information recording unit.
